(19) United States
(12) Patent Application Publication
(10) Pub. No.: US 2026/0001274 A1
(43) Pub. Date: Jan. 1, 2026

(54) METHOD FOR PRODUCING THREE-DIMENSIONAL OBJECT

(71) Applicant: MIMAKI ENGINEERING CO., LTD., Nagano (JP)

(72) Inventors: Ryo Nishizawa, Nagano (JP); Kenta Hongo, Nagano (JP)

(73) Assignee: MIMAKI ENGINEERING CO., LTD., Nagano (JP)

(21) Appl. No.: 18/859,987

(22) PCT Filed: Apr. 17, 2023
(86) PCT No.: PCT/JP2023/015326

§ 371 Date: Jul. 7, 2025

(30) Foreign Application Priority Data
Apr. 28, 2022 (JP) 2022-075022

(51) Int. Cl. B29C 64/30; B29C 64/112; B33Y 10/00; B33Y 70/00

(52) U.S. Cl. CPC B29C 64/30; B29C 64/112; B33Y 10/00; B33Y 70/00; B29K 2995/002

(57) ABSTRACT

Discoloration of a three-dimensional object formed by three-dimensional forming using an electron beam curable ink is effectively decreased.

A method for producing a three-dimensional object includes a preparing step S1 of preparing a treated three-dimensional object formed by three-dimensional forming using an electron beam curable ink; and an aging step S2 of performing irradiation treatment S2-1 in which the treated three-dimensional object is irradiated with light including wavelengths of less than 430 nm and heat treatment S2-2 in which heat is applied to the treated three-dimensional object, to decrease color tone of a discolored portion in the treated three-dimensional object.

### TECHNICAL FIELD

The present invention relates to a method for producing a three-dimensional object.

### BACKGROUND ART

As a method for forming a three-dimensional object, a method for forming three-dimensional shapes using electron beam curable inks such as UV curable inks has been known.

For example, the three-dimensional shapes are formed by forming an ink layer by ejecting a liquid electron beam curable ink using an inkjet or a dispenser, forming a cured ink layer in which the ink is cured by irradiating the ink layer with electron beams to cure the ink, and by repeating this ejection and curing, depositing the curable ink layers.

Depending on the three-dimensional objects, a transparent ink (clear ink) and a color ink may be used as the electron beam curable inks. In this case, the three-dimensional object is constituted of a transparent portion of the area of the clear ink and a colored portion of the area of the color ink. After production, such a three-dimensional object may be yellowed in the transparent portion or discolored in the colored portion.

As a method for reducing the discoloration of a three-dimensional object, Patent Literature 1 has described a treating method for irradiating the three-dimensional object with light including light having wavelengths within the range of 430 nm to 500 nm and not including light having wavelengths of 400 nm or less so that the total irradiation intensity of the light having wavelengths of 430 nm to 500 nm on the surface of the three-dimensional object is 15 W/m² or more.

### CITATION LIST

### Patent Literature

Patent Literature 1: Japanese Patent No. 5393239

### SUMMARY OF INVENTION

### Technical Problem

In the treatment method described in Patent Literature 1, however, reduction in discoloration may be difficult or time for reducing the discoloration may be long.

Therefore, effective decrease in the discoloration of the three-dimensional object formed by three-dimensional forming using the electron beam curable ink has been required.

### SOLUTIONS TO THE PROBLEMS

When analyzing the three-dimensional object formed by three-dimensional forming using the electron beam curable ink, the inventors of the present invention have found that the discoloration is caused by the remaining portion of a polymerization initiator, intermediate products, and the like, reduction in the discoloration by irradiating with predetermined light is caused by disappearance of the remaining portion of the polymerization initiator and the intermediate products, and the reduction in the discoloration is caused by additional heating.

The present invention provides a method for producing a three-dimensional object, comprising:
a preparing step of preparing a treated three-dimensional object formed by three-dimensional forming using an electron beam curable ink; and
an aging step of performing irradiation treatment in which the treated three-dimensional object is irradiated with light including wavelengths of less than 430 nm and heat treatment in which heat is applied to the treated three-dimensional object, to decrease color tone of a discolored portion in the treated three-dimensional object.

According to the present invention, the discoloration of the three-dimensional object formed by three-dimensional forming using the electron beam curable ink can be effectively decreased.

In the method for producing a three-dimensional object according to one aspect of the present invention, the irradiation treatment and the heat treatment are preferably performed in parallel in the aging step.

According to the present invention, the rate of decrease in the color tone of the discolored portion is fast.

In the method for producing a three-dimensional object according to one aspect of the present invention, the electron beam curable ink preferably comprises at least one selected from the group consisting of a phosphine oxide-based photopolymerization initiator, an alkylphenone-based photopolymerization initiator, a thioxanthone-based photopolymerization initiator, an acyl phosphine oxide-based photopolymerization initiator, and a titanocene-based photopolymerization initiator as a photopolymerization initiator.

According to the present invention, the effect of decrease in the color tone of the discolored portion discolored by the intermediate products generated by the photopolymerization reaction and the remaining portion of the photopolymerization initiator that cannot fully react in the photopolymerization reaction is significant.

In the method for producing a three-dimensional object according to one aspect of the present invention, the heat treatment preferably applies a heat of 10° C. or more and 100° C. or less.

According to the present invention, the rate of decrease in the color tone of the discolored portion is fast.

### Effect of the Invention

According to the present invention, the discoloration of the three-dimensional object formed by three-dimensional forming using the electron beam curable ink can be effectively decreased.

### DESCRIPTION OF THE DRAWINGS

FIG. 1 is a flowchart of a method for producing a three-dimensional object according to an embodiment of the present invention.

FIG. 2 is a schematic view illustrating a treated three-dimensional object according to one embodiment of the present invention.

FIG. 3 is a graph illustrating an aging effect.

FIG. 4 is a graph illustrating a spectral spectrum of a light source (a fluorescent lamp on an indoor ceiling) in Experimental Example 1.

FIG. 5 is a graph illustrating illuminance and a spectral spectrum of a light source (a three-wavelength fluorescent lamp of 45 W) in Experimental Example 2.

FIG. 6 is a graph illustrating illuminance and a spectral spectrum of a light source (single-wavelength lamp (385 nm)) in Experimental Example 4.

FIG. 7 is a graph illustrating illuminance and a spectral spectrum of a light source (single-wavelength lamp (405 nm)) in Experimental Example 5.

FIG. 8 is a graph illustrating illuminance and a spectral spectrum of a light source (incandescent light bulb (UVA+UVB)) in Experimental Example 8.

FIG. 9 is a graph illustrating illuminance and a spectral spectrum of a light source (three-wavelength incandescent light bulb (Hyper Sun UV100W)) in Experimental Example 9.

FIG. 10 is a graph illustrating illuminance and a spectral spectrum of a light source (LED lamp (incandescent light bulb 100-type daylight color)) in Experimental Example 10.

FIG. 11 is a graph illustrating aging effects in Comparative Examples 2 to 5.

FIG. 12 is a graph illustrating aging effects in Comparative Examples 6 to 9.

FIG. 13 is a graph illustrating aging effects in Comparative Examples 10 to 12.

FIG. 14 is a graph illustrating aging effects in Examples 1 to 4.

### DESCRIPTION OF EMBODIMENT

Subsequently, the method for producing a three-dimensional object according to one embodiment of the present invention will be described with reference to the drawings. The present invention, however, is not limited thereto.

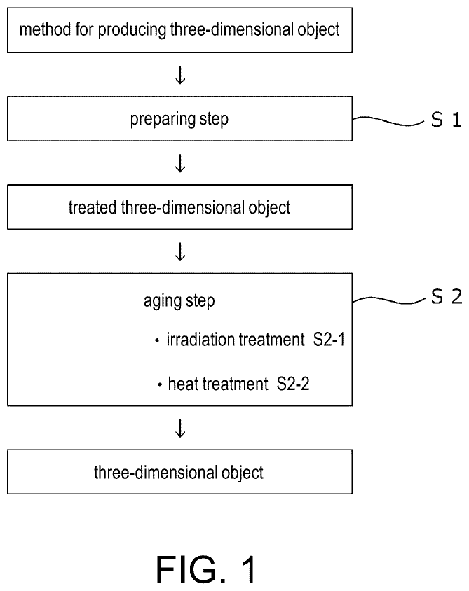

The production method of the present invention includes a preparing step S1 and an aging step S2 as illustrated in FIG. 1. Hereinafter, each step will be described in detail.

### (Preparing Step S1)

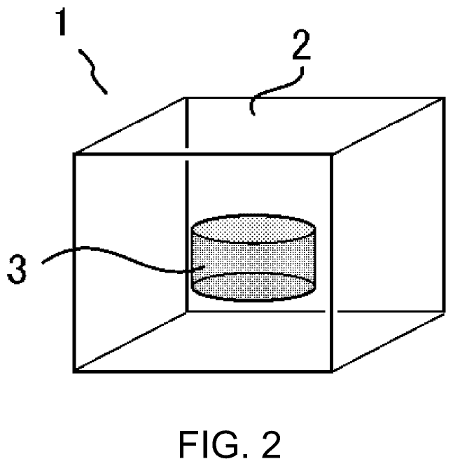

In the preparing step S1, a treated three-dimensional object 1 formed by three-dimensional forming using an electron beam curable ink is prepared (refer to FIG. 1). FIG. 2 is a schematic view illustrating the treated three-dimensional object 1. The treated three-dimensional object 1 has a colorless transparent portion 2 and a colored opaque portion 3.

The electron beam curable ink according to the present embodiment includes, for example, an electron beam curable compound, a photopolymerization initiator, a sensitizer, a colorant, and other components.

Examples of the electron beam curable compound include radical polymerizable compounds. The radical polymerizable compounds are not particularly limited as long as the compounds have radical polymerization properties. Acrylates are preferable from the viewpoint of polymerization properties, durability of cured matter, and solubility of the initiator and the sensitizer.

Examples of the acrylates include monofunctional acrylates such as phenol-EO-modified acrylate, nonylphenol-EO-modified acrylate, and ethoxydiethylene glycol acrylate, bifunctional acrylates such as hexanediol diacrylate, hexanediol-EO-modified diacrylate, neopentyl glycol hydroxypivalate diacrylate, neopentyl glycol-PO-modified diacrylate, tripropylene glycol diacrylate, dipropylene glycol diacrylate, bisphenol A-EO-modified diacrylate, polyethylene glycol diacrylate, and polypropylene glycol diacrylate, and multifunctional acrylates such as trimethylolpropane triacrylate, trimethylolpropane-EO-modified triacrylate, trimethylolpropane-PO-modified triacrylate, glycerol propoxy triacrylate, pentaerythritol triacrylate, pentacrythritol-EO-modified tetraacrylate, ditrimethylolpropane tetraacrylate, and dipentaerythritol hexaacrylate.

These radical polymerizable compounds may be used singly or in combination of them.

The photopolymerization initiator generates radicals when irradiated with light and cures the electron beam curable compounds. In particular, photopolymerization initiators that are effective in the case where the product is cured by light emitted from LEDs are preferable. Examples of the photopolymerization initiator include aminoalkylphenone-based photopolymerization initiators, phosphine oxide-based photopolymerization initiators, alkylphenone-based photopolymerization initiators, thioxanthone-based photopolymerization initiators, acyl phosphine oxide-based photopolymerization initiators, and titanocene-based photopolymerization initiators. Iodonium salt-based photopolymerization initiators and sulfonium salt-based photopolymerization initiators may also be used as cationic photopolymerization initiators. These photopolymerization initiators may be singly included in the ink or may be included in the ink by mixing two or more of the photopolymerization initiators.

Examples of the aminoalkylphenone-based photopolymerization initiators include 2-methyl-1-[4-(methylthio)phenyl]-2 morpholinopropan-1-one, 2-benzyl-2-(dimethylamino)-4′-morpholinobutyrophenone, and 2-dimethylamino-2-(4-methylbenzyl)-1-(4-morpholin-4-yl-phenyl)-butan-1-one.

Examples of the phosphine oxide-based photopolymerization initiators include 2,4,6-trimethylbenzoyl-diphenylphosphine oxide and bis(2,4,6-trimethylbenzoyl)phenylphosphine oxide.

Examples of the alkylphenone-based photopolymerization initiators include 1-hydroxy-cyclohexyl-phenyl-ketone and 2-methyl-1-(4-methylthiophenyl)-2-morpholinopropan-1-one. Examples of the thioxanthone-based polymerization initiators include 2-isopropylthioxanthone, 2,4-diethylthioxanthone, and 2-chlorothioxanthone.

Examples of the acyl phosphine oxide-based photopolymerization initiators include 2,4,6-trimethylbenzoyl-diphenyl-phosphine oxide and bis(2,4,6-trimethylbenzoyl)-phenylphosphine oxide.

Examples of the titanocene-based photopolymerization initiators include bis(cyclopentadienyl)-di-chloro-titanium, bis(cyclopentadienyl)-diphenyl-titanium, bis(cyclopentadienyl)-bis(2,3,4,5,6-pentafluorophenyl) titanium, bis(cyclopentadienyl)-bis(2,6-difluorophenyl) titanium, and bis(η5-cyclopentadienyl)-bis(2,6-difluoro-3-(1H-pyrrol-1-yl)phenyl) titanium.

Examples of the iodonium salt-based photopolymerization initiators of the cationic photopolymerization initiators include iodonium, (4-methylphenyl)[4-(2-methylpropyl)phenyl]-hexafluorophosphate. Examples of the sulfonium salt-based photopolymerization initiators include bis[4-(diphenylsulfonio)phenyl]sulfide bishexafluorophosphate.

The sensitizer provides photosensitivity to the photopolymerization initiator in a wavelength region having no light sensibility or increases the light sensitivity of the photopolymerization initiator. Examples of the sensitizer include thioxanthone-based sensitizers.

Examples of the thioxanthone-based sensitizers include thioxanthone, 2,4-diethyl-9H-thioxanthen-9-one, and 2-isopropylthioxanthone.

Examples of the colorant include known dyes and pigments. Examples of the pigments include inorganic and organic pigments. In the treated three-dimensional object 1 illustrated in FIG. 1, the colorless transparent portion 2 is the area of the electron beam curable ink that does not include any colorant or includes blue colorant to the extent that transparency is not impaired in order to decrease yellowish tone and the colored opaque portion 3 is the area of the electron beam curable ink that includes the colorant such as inorganic pigments or organic pigments.

Examples of the inorganic pigments include titanium oxide, zinc white, zinc oxide, lithopone, iron oxide, aluminum oxide, silicon dioxide, kaolinite, montmorillonite, talc, barium sulfate, calcium carbonate, silica, alumina, cadmium red, red iron oxide, molybdenum red, chrome vermilion, molybdate orange, lead yellow, chrome yellow, cadmium yellow, yellow iron oxide, titanium yellow, chromium oxide, pyridyan, cobalt green, titanium cobalt green, cobalt chrome green, indigo blue, ultramarine blue, Prussian blue, cobalt blue, cerulean blue, manganese violet, cobalt violet, and mica.

Examples of the organic pigments include azo-, azomethine-, polyazo-, phthalocyanine-, quinacridone-, anthraquinone-, indigo-, thioindigo-, quinophthalone-, benzimidazolone-, isoindoline-, and isoindolinone-based pigments and carbon black.

Examples of other components include fillers, colorants, dispersers, plasticizers, surface-active agents, surface modifiers, leveling agents, antifoaming agents, antioxidants, charge imparting agents, disinfectants, antiseptic, deodorants, charge modifiers, wetting agents, anti-skinning agents, fragrances, pigment derivatives, and solvents.

### (Three-Dimensional Forming)

In the three-dimensional forming using the electron beam curable ink, first, the electron beam curable ink is ejected to form an ink layer (ejecting step). Examples of the ink ejection method include inkjet methods and dispensing methods.

Subsequently, the ink layer formed in the ejecting step is irradiated with light having wavelengths of 405 nm to 420 nm, for example, to cure the ink layer (curing step).

Performing plurality of times of these ejecting step and curing step allows a three-dimensional object formed of the ink layers to be obtained. The ink ejecting step and the curing step may be performed alternately or the curing step may be performed after the ink ejecting steps are performed a few or several times.

In a preparing step S1, the ink is repeatedly ejected and cured to perform the three-dimensional forming, whereby the treated three-dimensional object 1 can be prepared. The treated three-dimensional object 1 may be obtained separately.

### (Aging Step S2)

In the present specification, the aging refers to treatment performed after the three-dimensional forming in order to decrease the discoloration. In the aging step S2, irradiation treatment S2-1, in which light irradiation is performed and heat treatment S2-2, in which heat is applied are performed to the treated three-dimensional object 1 prepared in the preparing step S1.

In the aging step S2, the irradiation treatment S2-4 and the heat treatment S2-2 may be performed in parallel or the heat treatment S2-2 may be performed after the irradiation treatment S2-1 is performed. Alternatively, the irradiation treatment S2-1 may be performed after the heat treatment S2-2 is performed.

Here, the photopolymerization initiator is decomposed by electron beam irradiation. In the preparing step S1 described above, however, a part of the photopolymerization initiator that is not fully decomposed and cannot contribute to the photopolymerization reaction may remain. The reaction caused by the photopolymerization initiator remaining in the treated three-dimensional object 1 proceeds, resulting in the discoloration of the treated three-dimensional object 1.

The treated three-dimensional object 1 also includes intermediate products such as residues generated by the photopolymerization reaction. The residue may also discolor the color tone of the treated three-dimensional object 1.

Therefore, in the present specification, the irradiation treatment S2-4 and the heat treatment S2-2 are performed in order to decrease the discoloration caused by these residues and the remaining portion of the photopolymerization initiator.

### (Irradiating Step S2-1)

In the irradiating step S2-1, the treated three-dimensional object 1 is irradiated with light including wavelengths of less than 430 nm. The wavelengths of less than 430 nm refer to wavelengths in the range where the residue, the remaining portion, and the like of the photopolymerization initiator can be removed from the treated three-dimensional object 1 and the components of the resin and the like that constitute the treated three-dimensional object 1 are not affected.

In the irradiating step S2-1, a light source emitting light including wavelengths of less than 430 nm is placed at an arbitrary distance from the treated three-dimensional object 1 and irradiates the treated three-dimensional object 1 with light.

The light source emitting light including wavelengths of less than 430 nm is not particularly limited as long as the light source emits the light having wavelengths of less than 430 nm. Examples of the light source include short-wavelength lamps and three-wavelength fluorescent lamps emitting the light having wavelengths of less than 430 nm.

The illuminance of the light is not particularly limited as long as an illuminance range allows aging to occur. In this case, the illuminance is preferably 20 W/m² or more, more preferably 50 W/m² or more, and particularly preferably 60 W/m² or more at the surface of the treated three-dimensional object 1. The illuminance of the light can also be adjusted by varying the distance between the light source and the treated three-dimensional object 1.

The decrease in the color tone of the discolored portions of the treated three-dimensional object 1 by the irradiation treatment S2-1 proceeds at a slower rate than that of the heat treatment S2-2, but the amount of color tone decrease is more than that of the heat treatment S2-2. For example, the time for the heat treatment S2-2 is preferably 1 hour or more, more preferably 2 hours or more, and particularly preferably 6 hours or more. The decrease rate in the color tone of the discolored portion in the treated three-dimensional object 1 gradually decreases, and even when the time for the heat treatment S2-2 is prolonged, the effect of the decrease in the color tone of the discolored portion decreases. Therefore, 24 hours or less is preferable from the viewpoint of the treatment time.

### (Heat Treatment S2-2)

In the heat treatment S2-2, heat is applied to the treated three-dimensional object 1.

Means of applying heat is not particularly limited. The heating may be performed by a heater or immersion in a thermostatic chamber. In the case where the irradiation treatment S2-1 is performed in parallel with the heat treatment S2-2, the light source used in the irradiation treatment S2-4 may also be used as a heat source.

The heat treatment S2-2 can be performed, for example, by placing the treated three-dimensional object 1 under a temperature condition of 10° C. or more and less than a temperature at which the treated three-dimensional object 1 deteriorates due to the heat. For example, the temperature condition is preferably 10° C. or more, more preferably 20° C. or more, and particularly preferably 30° C. or more. The temperature condition is preferably 100° C. or less, more preferably 80° C. or less, and particularly preferably 70° C. or less.

The decrease in the color tone of the discolored portion in the treated three-dimensional object 1 due to the heat treatment S2-2 proceeds at a faster rate than the rate in the irradiation treatment S2-1, but the amount of the decrease in the color tone is smaller than the amount in the irradiation treatment S2-1. For example, the time for the heat treatment S2-2 is preferably 1 hour or more, more preferably 2 hours or more, and particularly preferably 6 hours or more. The decrease rate in the color tone of the discolored portion in the treated three-dimensional object 1 gradually decreases. In addition, a longer time for the heat treatment S2-2 may cause heat-induced deformation or discoloration to occur. Therefore, 24 hours or less is preferable from the viewpoint of the treatment time. In addition, it is preferable that the time be appropriately adjusted depending on the temperature of the heat treatment S2-2.

### EXAMPLES

Hereinafter, the present invention will be described with reference to Examples. The present invention, however, is not limited to these Examples. The following methods were used to evaluate the characteristics of a light source and the effect of aging.

### (Illuminance)

A light source was placed at a predetermined distance from an evaluation sample to irradiate the evaluation sample with light. The illuminance was measured on the surface of the evaluation sample using a spectroradiometer (manufactured by KONICA MINOLTA, INC., trade name: CL-500A).

### (Spectral Spectrum (Spectral Waveform))

A light source was placed at a predetermined distance from the evaluation sample to irradiate the evaluation sample with light. The spectral irradiance was measured on the surface of the evaluation sample using the spectroradiometer (manufactured by KONICA MINOLTA, INC., trade name: CL-500A).

### (Chromaticity of Evaluation Sample)

The chromaticity was measured using a spectrophotometer (manufactured by KONICA MINOLTA, INC., trade name: CM-2600d) under the following conditions.
SN: D1012947
Light source: D65
Field of view: 10°
Reflection/Transmission: Reflection
Regular reflection light processing: SCI+SCE (values are controlled by SCE)
Measuring diameter: SAV (3 mm)

### (Aging Evaluation: Saturation c*)

Brightness L* and chromaticity a*b* were measured to determine the saturation c* and the rate at which discoloration is decreased and the final amount of the decrease were evaluated.
Sample shape: 30 mm×30 mm×20 mm
Measurement apparatus: Spectrophotometer (manufactured by KONICA MINOLTA, INC., trade name: CM-2600d)
The aging is excellent under conditions where c* is less than 10.

### (Aging Evaluation: Integrating Sphere Holder)

The degree of completion of the aging was confirmed by (1) UV-vis: disappearance of photopolymerization initiator-specific peaks and (2) colorimetry: confirmed particularly by b* transition.
Sample shape: 30 mm×30 mm×20 mm
Measurement apparatus: UV-vis (integrating sphere holder) (manufactured by JASCO Corporation, trade name: ISV-722)
Analysis: Color tones are calculated using analysis software provided with UV-vis.

The measurement with the integrating sphere is not affected by the background at the time of measurement and the color of the object itself can be measured.

### Production Example 1: Preparation of Evaluation Sample

An UV curable ink (manufactured by Mimaki Engineering Co., Ltd., trade name: MH-110PCL, components: acrylic monomer, oligomer, TPO, ACMO, and other components) was used as the electron beam curable ink and a transparent three-dimensional shape of 40 mm×40 mm×2 mm was formed to prepare a treated three-dimensional object E using an inkjet 3D printer (manufactured by Mimaki Engineering Co., Ltd., trade name: 3DUJ-553).

### Experimental Example 1

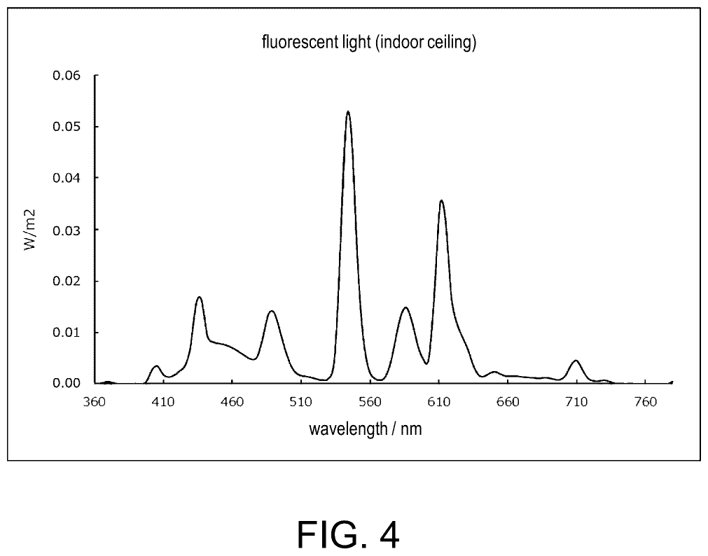

The spectral irradiance of a fluorescent light (3-wavelength type) on an indoor ceiling as a light source was measured. The spectral spectrum is illustrated in FIG. 4.

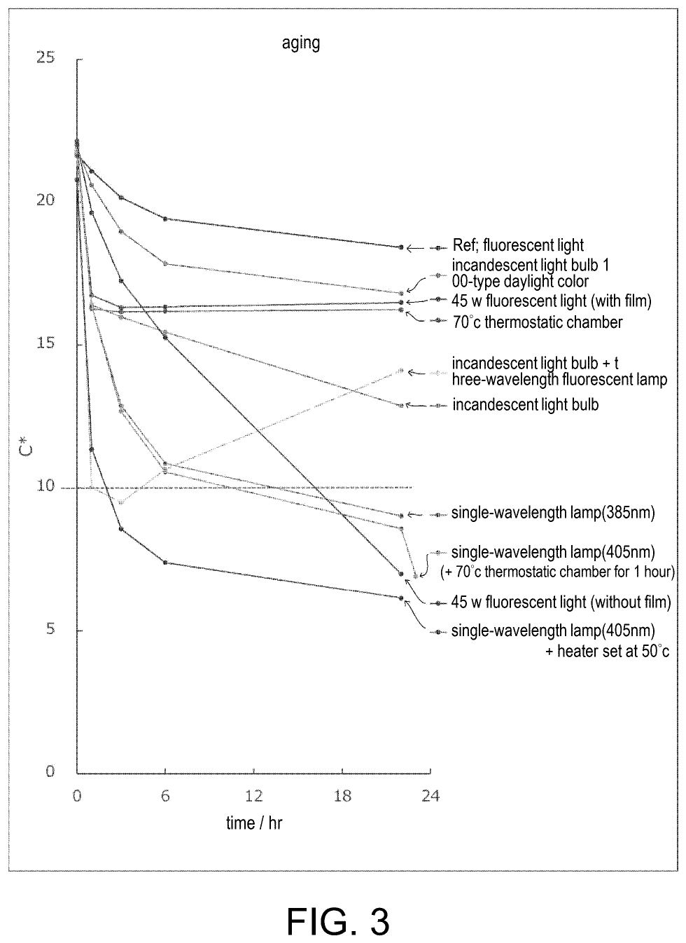

The treated three-dimensional object E was irradiated with light at the sample temperature of room temperature using a straight tube fluorescent lamp attached to an indoor ceiling as a light source to perform aging for 22 hours. The distance from the fluorescent light on the indoor ceiling as the light source to the treated three-dimensional object E is 1.9 m. The brightness L* and the chromaticity a*b* were measured initially and after 1, 3, 6, and 22 hours to determine the saturation c*. Both of the initial and after-22-hour illuminances were 2.4 W/m². The results are illustrated in FIG. 3. The term “initial” here means the point of the time (zeroth hour) when the light irradiation begins to start the aging.

### Experimental Example 2

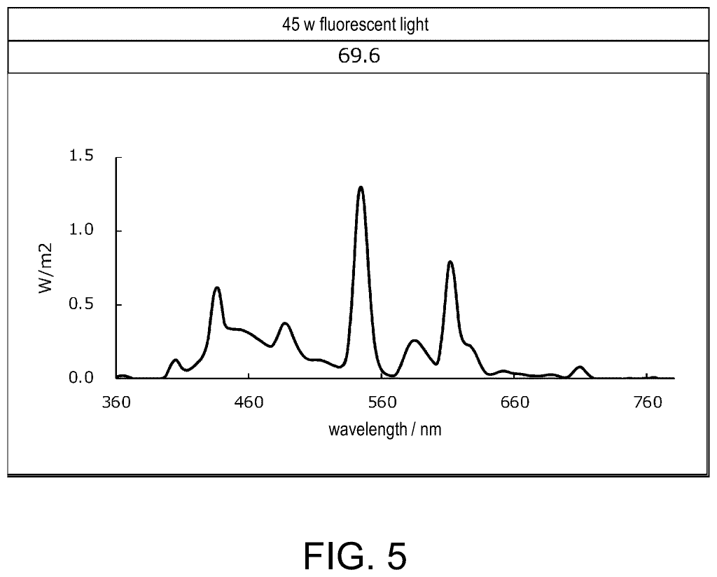

The illuminance and the spectral irradiance of a 45 W bulb-type three-wavelength fluorescent lamp (ALBA ALB-45F) as a light source were measured at a distance of 20 cm. The illuminance was 69.6 W/m². The illuminance and the spectral spectrum are illustrated in FIG. 5 (here, the term “bulb-type” means a fluorescent lamp of which fluorescent tube is spherical, spiral-shaped, D-shaped, or the like).

The treated three-dimensional object E was irradiated with light at a distance of 5 cm using a 45W three-wavelength fluorescent lamp (ALBAALB-45F (a UV blocking film (WINCOS Wincos (formerly Lumicool) 1905UH, manufactured by yamahira Corporation, blocking UV rays of 300 nm to 500 nm)) is included) as the light source to perform aging for 22 hours. The sample surface was heated by the lamp and the sample surface temperature was 60° C. The brightness L* and the chromaticity a*b* were measured initially and after 1, 3, 6, and 22 hours to determine the saturation c*. The initial and after-22-hour illuminances were 76.7 W/m² and 50.3 W/m², respectively. The results are illustrated in FIG. 3.

### Experimental Example 3

The treated three-dimensional object E was irradiated with light at a distance of 18 cm using a 45 W bulb-type three-wavelength fluorescent lamp (ALBAALB-45F (without UV blocking film, that is, including light having wavelengths of less than 430 nm)) as the light source to perform aging for 22 hours. The sample surface was heated by the lamp and the sample surface temperature was 35° C. In other words, in Experimental Example 3, the irradiation treatment S2-1 and the heat treatment S2-2 are performed in parallel.

The brightness L* and the chromaticity a*b* were measured initially and after 1, 3, 6, and 22 hours to determine the saturation c*. The initial and after-22-hour illuminances were 80.7 W/m² and 48.1 W/m², respectively. The results are illustrated in FIG. 3.

### Experimental Example 4

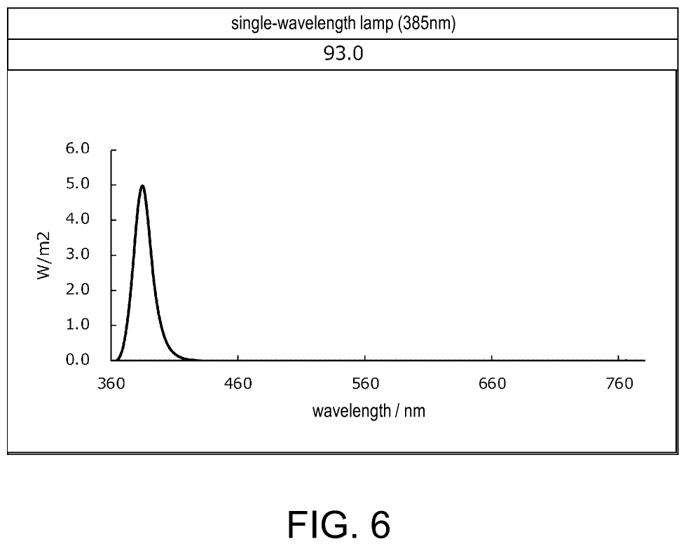

The illuminance and the spectral irradiance of a single-wavelength lamp emitting light having a wavelength of 385 nm (light including wavelengths of less than 430 nm) as a light source were measured at a distance of 20 cm. The illuminance was 93.0 lux. The illuminance and the spectral spectrum are illustrated in FIG. 6.

The treated three-dimensional object E was irradiated with light at a distance of 22 cm using a single-wavelength lamp (385 nm) as a light source to perform aging for 22 hours. The sample surface was heated by the lamp and the sample surface temperature was 28° C. The brightness L* and the chromaticity a*b* were measured initially and after 1, 3, 6, and 22 hours to determine the saturation c*. The initial and after-22-hour illuminances were 76.2 W/m² and 67.2 W/m², respectively. The results are illustrated in FIG. 3.

### Experimental Example 5

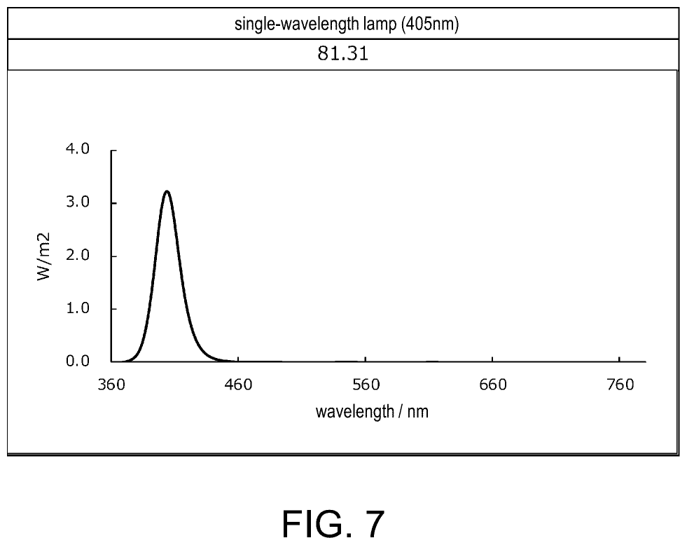

The illuminance and the spectral irradiance of a single-wavelength lamp (405 nm) (INTEGRATION405) emitting 405-nm light (light including wavelengths of less than 430 nm) as a light source were measured at a distance of 20 cm. The illuminance was 81.31 lux. The illuminance and the spectral spectrum are illustrated in FIG. 7.

The treated three-dimensional object E was irradiated with light at a distance of 20 cm using a single-wavelength lamp (405 nm) (INTEGRATION405) as a light source to perform aging for 22 hours. The sample surface was heated by the lamp and the sample surface temperature was 26° C. The brightness L* and the chromaticity a*b* were measured initially and after 1, 3, 6, and 22 hours to determine the saturation c*. The initial and after-22-hour illuminances were 82.3 W/m² and 85.6 W/m², respectively. The results are illustrated in FIG. 3.

### Experimental Example 6

The evaluation sample after the aging for 22 hours in Experimental Example 5 was further aged in a thermostatic chamber at 70° C. for 1 hour. In other words, in Experimental Example 6, the heat treatment S2-2 is performed after the irradiation treatment S2-1. The results are illustrated in FIG. 3.

### Experimental Example 7

The treated three-dimensional object E was irradiated with light of 405 nm (light including wavelengths of less than 430 nm) at a distance of 20 cm using a single-wavelength lamp (405 nm) (INTEGRATION405) as a light source at a heater setting of 50° C. (heater surface temperature: 40° C., sample surface temperature: 38° C.) to perform aging for 22 hours. In other words, in Experimental Example 7, the irradiation treatment S2-1 and the heat treatment S2-2 are performed in parallel. The results are illustrated in FIG. 3.

### Experimental Example 8

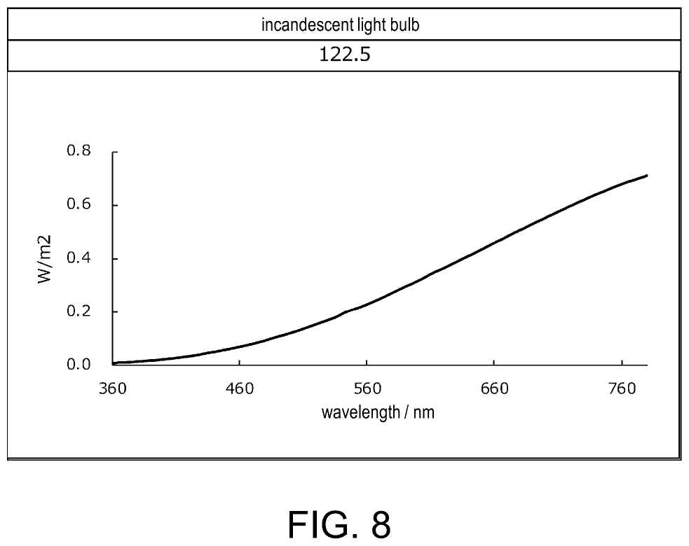

The illuminance and the spectral irradiance of an incandescent light bulb (UVA+UVB) as a light source were measured at a distance of 20 cm. The illuminance was 122.5 lux. The illuminance and the spectral spectrum are illustrated in FIG. 8.

The treated three-dimensional object E was irradiated with light at a distance of 24 cm using the incandescent light bulb (UVA+UVB) as a light source to perform aging for 22 hours. The sample surface was heated by the lamp and the sample surface temperature was 57° C. The brightness L* and the chromaticity a*b* were measured initially and after 1, 3, 6, and 22 hours to determine the saturation c*. The initial and after-22-hour illuminances were 79.7 W/m² and 76.1 W/m², respectively. The results are illustrated in FIG. 3.

### Experimental Example 9

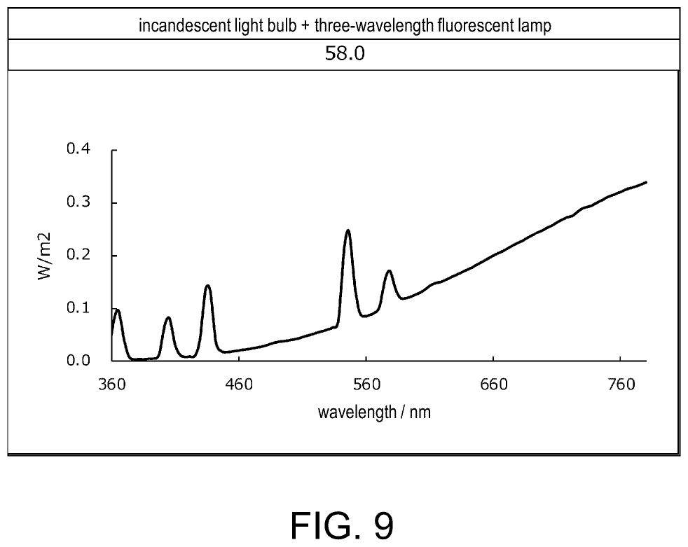

The illuminance and the spectral irradiance of a 3-wavelength incandescent light bulb (Hyper Sun UV100W) as a light source were measured at a distance of 20 cm. The illuminance was 58.0 lux. The illuminance and the spectral spectrum are illustrated in FIG. 9.

The treated three-dimensional object E was irradiated with light at a distance of 12 cm using the 3-wavelength incandescent light bulb (Hyper Sun UV 100W) as a light source to perform aging for 22 hours. The sample surface was heated by the lamp and the sample surface temperature was 90° C. The brightness L* and the chromaticity a*b* were measured initially and after 1, 3, 6, and 22 hours to determine the saturation c*. The initial and after 22-hour illuminances were 56.1 W/m² and 75.4 W/m², respectively. The results are illustrated in FIG. 3.

### Experimental Example 10

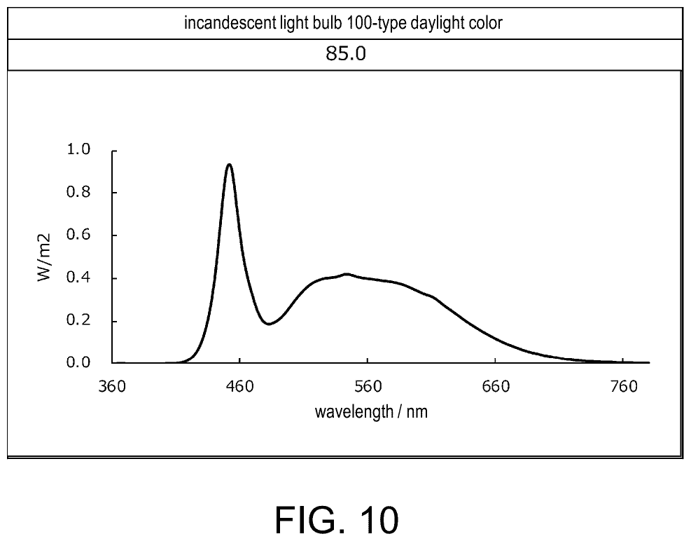

The illuminance and the spectral irradiance of a LED lamp (incandescent light bulb type 100, daylight color) as a light source were measured at a distance of 20 cm. The illuminance was 83.0 lux. The illuminance and the spectral spectrum are illustrated in FIG. 10.

The treated three-dimensional object E was irradiated with light at a distance of 20 cm using the LED lamp (incandescent light bulb type 100, daylight white) as a light source to perform aging for 22 hours. The sample surface was heated by the lamp and the sample surface temperature was 30° C. The brightness L* and the chromaticity a*b* were measured initially and after 1, 3, 6, and 22 hours to determine the saturation c*. The initial and after-22-hour illuminances were 75.0 W/m² and 71.3 W/m², respectively. The results are illustrated in FIG. 3.

### Experimental Example 11

The treated three-dimensional object E was immersed in a thermostatic chamber at 70° C. without using a light source to perform aging for 22 hours. The brightness L* and the chromaticity a*b* were measured initially and after 1, 3, 6, and 22 hours to determine the saturation c*. The initial and after-22-hour illuminances were 75.0 W/m² and 71.3 W/m², respectively. The results are illustrated in FIG. 3.

### Summary of Experimental Examples 1 to 11

In Experimental Examples 1 to 11, c* was measured using a colorimeter. Aging is excellent under conditions where c* is less than 10, although this c* may be affected by the color of the background on which the sample is placed during measurement. Specifically, compared to the case where the sample is placed under the fluorescent light on the indoor ceiling (Experimental Example 1), a certain degree of the aging effect can be obtained by irradiating the sample with any light or applying heat alone. However, the decrease in the discoloration is insufficient or slow.

In contrast, as in Experimental Examples 3, 6, and 7, in the case of performing the irradiation treatment S2-1, in which the sample was irradiated with light including wavelengths of less than 430 nm and the heat treatment S2-2, in which heat was applied to the sample, the aging effect was faster and the decrease in the discoloration was superior. The aging proceeded fast particularly in Experimental Examples 3 and 7, in which the irradiation treatment S2-1 and the heat treatment S2-2 were performed in parallel, out of Experimental Examples 3, 6, and 7.

### Comparative Example 1

In Comparative Example 1, both of the irradiation treatment S2-1 and the heat treatment S2-2 were not performed.

Specifically, in Comparative Example 1, the treated three-dimensional object E was stored in a dark place for 40 hours to examine the change in the discoloration. The brightness L* and the chromaticity a*b were measured initially and after 8, 16, 40, and 64 hours with an integrating sphere holder to determine the saturation c*. The results are listed in Table 1.

TABLE 1

| | | Initial | 8 h | 16 h | 40 h | 64 h |
|---|---|---|---|---|---|---|
| Stored in | L* | 91.11 | 91.16 | 91.14 | 91.16 | 91.26 |
| dark place | a* | −4.1 | −4.1 | −4.1 | −4.21 | −4.1 |
| | b* | 10.27 | 10.21 | 10.14 | 10.29 | 9.84 |
| | c* | 11.1 | 11.0 | 10.9 | 11.1 | 10.7 |
| | ΔE | 0 | 0.08 | 0.13 | 0.12 | 0.46 |

### Comparative Examples 2 to 5

In Comparative Examples 2 to 5, only the heat treatment S2-2 was performed.

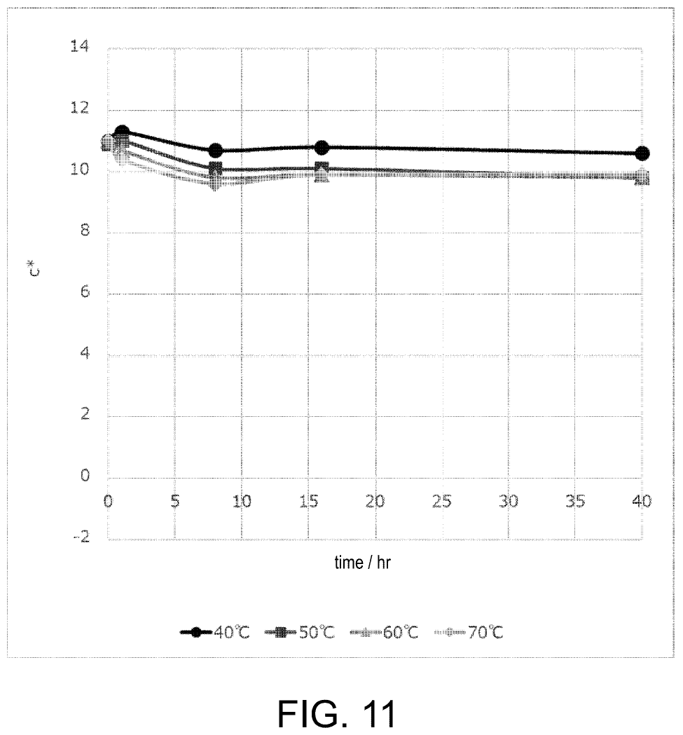

Specifically, in Comparative Examples 2 to 5, the treated three-dimensional object E was not irradiated with light and only heated (40° C., 50° C. 60° C. and 70° C. each) to perform aging for 40 hours. The brightness L* and the chromaticity a*b* were measured at initially and after 1, 8, 16, and 40 hours with an integrating sphere holder to determine the saturation c*. The results are listed in Table 2 and illustrated in FIG. 11.

TABLE 2

| | | Initial | 1 h | 8 h | 16 h | 40 h |
|---|---|---|---|---|---|---|
| Heated | L* | 91.19 | 91.22 | 91.36 | 91.41 | 91.51 |
| at 40° C. | a* | −4.26 | −4.24 | −4.12 | −4.17 | −4.25 |
| | b* | 10.14 | 10.43 | 9.9 | 9.95 | 9.69 |
| | c* | 11.0 | 11.3 | 10.7 | 10.8 | 10.6 |
| | ΔE | 0 | 0.29 | 0.33 | 0.30 | 0.55 |
| Heated | L* | 91.26 | 91.3 | 91.3 | 91.38 | 91.47 |
| at 50° C. | a* | −4.14 | −4.17 | −4.07 | −4.18 | −4.22 |
| | b* | 10.12 | 10.17 | 9.24 | 9.2 | 8.87 |
| | c* | 10.9 | 11.0 | 10.1 | 10.1 | 9.8 |
| | ΔE | 0 | 0.07 | 0.88 | 0.93 | 1.27 |
| Heated | L* | 91.34 | 91.42 | 91.58 | 91.65 | 91.65 |
| at 60° C. | a* | −4.16 | −4.21 | −4.17 | −4.28 | −4.36 |
| | b* | 10.14 | 9.88 | 8.85 | 8.93 | 8.78 |
| | c* | 11.0 | 10.7 | 9.8 | 9.9 | 9.8 |
| | ΔE | 0 | 0.28 | 1.31 | 1.25 | 1.41 |
| Heated | L* | 91.23 | 91.45 | 91.62 | 91.56 | 91.55 |
| at 70° C. | a* | −4.15 | −4.22 | −4.24 | −4.36 | −4.4 |
| | b* | 10.15 | 9.53 | 8.66 | 8.84 | 8.86 |
| | c* | 11.0 | 10.4 | 9.6 | 9.9 | 9.9 |
| | ΔE | 0 | 0.66 | 1.54 | 1.37 | 1.35 |

### Comparative Examples 6 to 9

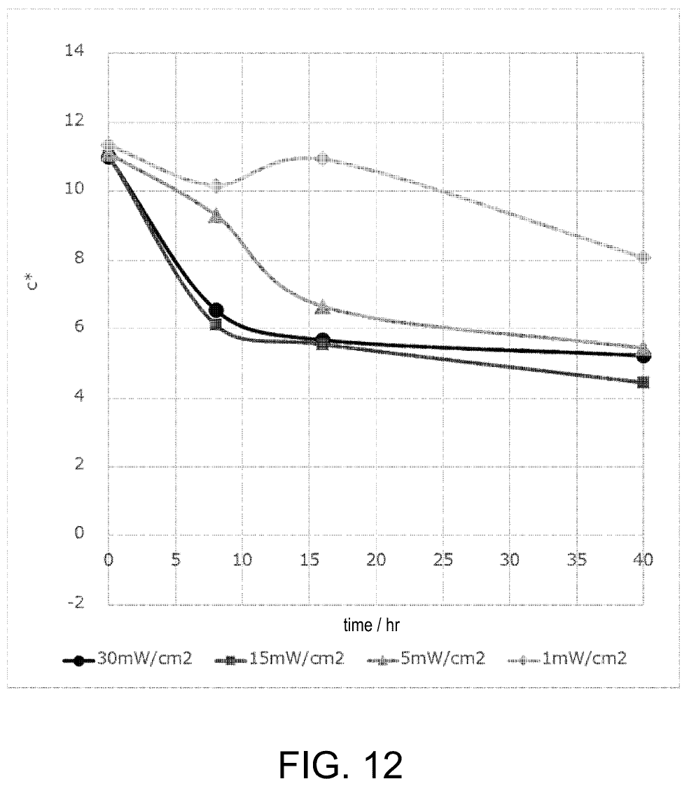

In Comparative examples 6 to 9, only the irradiation treatment S241 was performed. Specifically, in Comparative Examples 6 to 9, the treated three-dimensional object E was irradiated at adjusted distances with light using a single-wavelength lamp (INTEGRATION405) as a light source that irradiates the object with 405 nm light (light including wavelengths of less than 430 nm) at an illuminance of 30 mW/cm², 15 mW/cm², 5 mW/cm², and 1 mW/cm² to perform aging for 40 hours. The brightness L* and the chromaticity a*b* were measured initially and after 8, 16, and 40 hours with an integrating sphere holder to determine the saturation c*. The results are listed in Table 3 and illustrated in FIG. 12.

TABLE 3

| UV illuminance | | Initial | 8 h | 16 h | 40 h |
|---|---|---|---|---|---|
| 30 mW/cm² | L* | 91.35 | 90.56 | 90.66 | 91.02 |
| | a* | −4.17 | −0.75 | −0.37 | −0.18 |
| | b* | 10.18 | 6.51 | 5.67 | 5.23 |
| | c* | 11.0 | 6.6 | 5.7 | 5.2 |
| | ΔE | 0 | 5.08 | 5.94 | 6.37 |
| 15 mW/cm² | L* | 91.41 | 90.82 | 90.83 | 91.07 |
| | a* | −4.16 | −0.87 | −0.57 | −0.17 |
| | b* | 10.2 | 6.06 | 5.53 | 4.45 |
| | c* | 11.0 | 6.1 | 5.6 | 4.5 |
| | ΔE | 0 | 5.32 | 5.92 | 7.01 |
| 5 mW/cm² | L* | 91.22 | 90.69 | 90.82 | 90.94 |
| | a* | −4.2 | −2.01 | −1.24 | −1.01 |
| | b* | 10.27 | 9.09 | 6.54 | 5.35 |
| | c* | 11.1 | 9.3 | 6.7 | 5.4 |
| | ΔE | 0 | 2.54 | 4.78 | 5.87 |
| 1 mW/cm² | L* | 91.2 | 91.27 | 91.03 | 90.99 |
| | a* | −4.22 | −3.74 | −3.52 | −2.14 |
| | b* | 10.52 | 9.45 | 10.35 | 7.8 |
| | c* | 11.3 | 10.2 | 10.9 | 8.1 |
| | ΔE | 0 | 1.17 | 0.74 | 3.43 |

### Comparative Examples 10 to 12

In Comparative Examples 10 to 12, only the irradiating step S241 was performed.

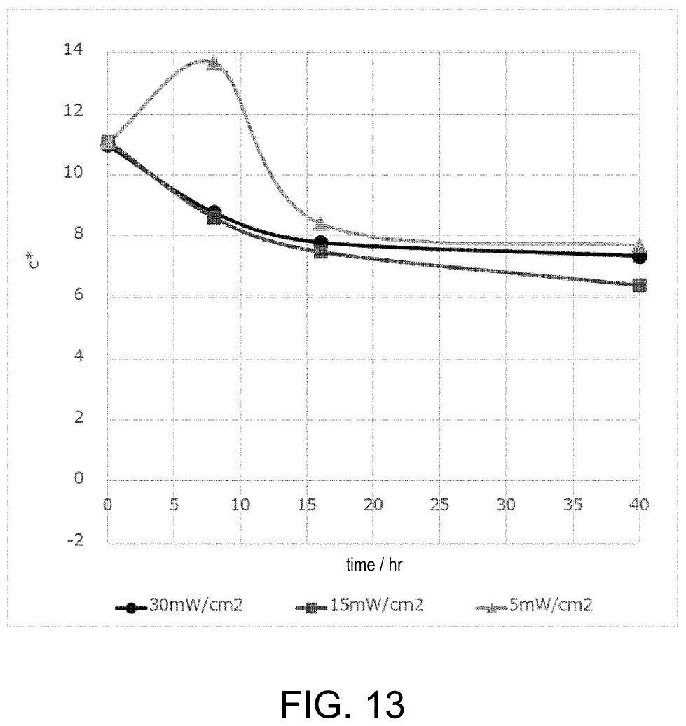

Specifically, in Comparative Examples 10 to 12, the treated three-dimensional object Ei was irradiated at adjusted distances with light using a single-wavelength lamp as a light source that irradiates the object with 385 nm light (light including wavelengths of less than 430 nm) at an illuminance of 30 mW/cm², 15 mW/cm², and 5 mW/cm² to perform aging for 40 hours. The brightness L* and the chromaticity a*b* were measured initially and after 8, 16, and 40 hours with an integrating sphere holder to determine the saturation c*. The results are listed in Table 4 and illustrated in FIG. 13.

TABLE 4

| UV illuminance | | Initial | 8 h | 16 h | 40 h |
|---|---|---|---|---|---|
| 30 mW/cm² | L* | 91.41 | 90.4 | 90.58 | 91.07 |
| | a* | −4.16 | −1.05 | −0.65 | −0.44 |
| | b* | 10.16 | 8.71 | 7.77 | 7.34 |
| | c* | 11.0 | 8.8 | 7.8 | 7.4 |
| | ΔE | 0 | 3.58 | 4.33 | 4.68 |
| 15 mW/cm² | L* | 91.36 | 90.54 | 90.66 | 91.09 |
| | a* | −4.19 | −1.27 | −0.77 | −0.29 |
| | b* | 10.28 | 8.51 | 7.46 | 6.4 |
| | c* | 11.1 | 8.6 | 7.5 | 6.4 |
| | ΔE | 0 | 3.51 | 4.49 | 5.51 |
| 5 mW/cm² | L* | 91.42 | 90.69 | 90.76 | 90.62 |
| | a* | −4.19 | −3.51 | −1.64 | −1.05 |
| | b* | 10.24 | 13.19 | 8.27 | 7.63 |
| | c* | 11.1 | 13.6 | 8.4 | 7.7 |
| | ΔE | 0 | 3.11 | 3.29 | 4.16 |

### Examples 1 to 4

In Examples 1 to 4, the irradiation treatment S2-1 and the heat treatment S2-2 were performed in parallel.

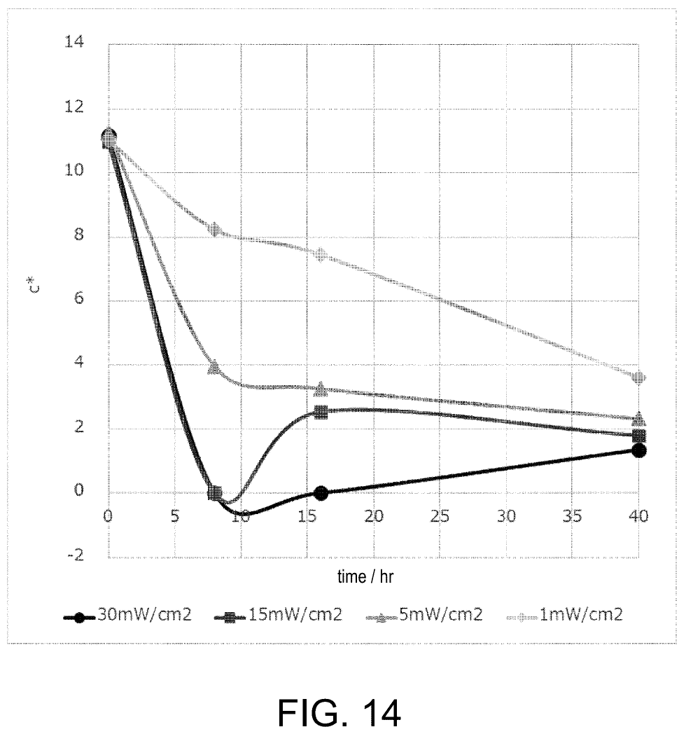

Specifically, in Examples 1 to 4, the treated three-dimensional object E was heated at 70° C. while being irradiated at adjusted distances with light using a single-wavelength lamp (INTEGRATION405) as a light source that irradiates the object with 405 nm light (light including wavelengths of less than 430 nm) at an illuminance of 30 mW/cm², 15 mW/cm², 5 mW/cm², and 1 mW/cm² to perform aging for 40 hours. The brightness L* and the chromaticity a*b* were measured initially and after 8, 16, and 40 hours with an integrating sphere holder to determine the saturation c*. The results are listed in Table 5 and illustrated in FIG. 14.

TABLE 5

| UV illuminance | | Initial | 8 h | 16 h | 40 h |
|---|---|---|---|---|---|
| 30 mW/cm² | L* | 91.22 | | | 92.21 |
| | a* | −4.42 | | | 0.05 |
| | b* | 10.26 | | | 1.35 |
| | c* | 11.2 | 0.0 | 0.0 | 1.4 |
| | ΔE | 0 | 91.90 | 91.90 | 10.02 |
| 15 mW/cm² | L* | 91.26 | | 91.61 | 91.98 |
| | a* | −4.13 | | −0.57 | −0.12 |
| | b* | 10.16 | | 2.48 | 1.8 |
| | c* | 11.0 | 0.0 | 2.5 | 1.8 |
| | ΔE | 0 | 91.92 | 8.47 | 9.30 |
| 5 mW/cm² | L* | 91.35 | 91.36 | 91.4 | 91.57 |
| | a* | −4.21 | −1.05 | −0.82 | −0.49 |
| | b* | 10.43 | 3.83 | 3.17 | 2.28 |
| | c* | 11.2 | 4.0 | 3.3 | 2.3 |
| | ΔE | 0 | 7.32 | 8.01 | 8.96 |
| 1 mW/cm² | L* | 91.15 | 91.19 | 91.22 | 91.29 |
| | a* | −4.15 | −2.96 | −2.78 | −1.17 |
| | b* | 10.21 | 7.69 | 6.91 | 3.41 |
| | c* | 11.0 | 8.2 | 7.4 | 3.6 |
| | ΔE | 0 | 2.79 | 3.57 | 7.43 |

### Summary of Comparative Examples 1 to 12 and Examples 1 to 4

In Comparative Example 1, the sample was stored in a dark place, indicating that little aging effect is achieved.

In Comparative Examples 2 to 5, where only the heat treatment S2-2 was performed, heat treatment at high temperature allows a certain degree of the aging effect to be observed after 8 hours. However, it is found that decrease in discoloration is insufficient.

In Comparative Examples 6 to 9 and 10 to 12, where only the irradiation treatment S2-1 was performed, the aging effect can be observed to some extent at high illuminance. However, the rate of aging is slow and the rate does not provide any effect when the illuminance was increased from 15 mW/cm² to 30 mW/cm².

In contrast, in Examples 1 to 4, where the irradiation treatment S2-1 and the heat treatment S2-2 were performed in parallel, a sufficient aging effect was able to be already observed after 8 hours.

As described above, the embodiments of the present invention are described. These embodiments are intended to describe the present invention and are not intended to limit the scope of the invention. The present invention can be appropriately modified within the scope of the technical concept of the present invention.

### DESCRIPTION OF REFERENCE SIGNS

1, E Treated three-dimensional object
2 Colorless transparent portion
3 Colored opaque portion
S1 Preparing step
S2 Aging step
S2-1 Irradiation treatment
S2-2 Heat treatment

1. A method for producing a three-dimensional object, comprising:
a preparing step of preparing a treated three-dimensional object formed by three-dimensional forming using an electron beam curable ink; and
an aging step of performing irradiation treatment in which the treated three-dimensional object is irradiated with light including wavelengths of less than 430 nm and heat treatment in which heat is applied to the treated three-dimensional object, to decrease color tone of a discolored portion in the treated three-dimensional object.

2. The method for producing a three-dimensional object according to claim 1, wherein the irradiation treatment and the heat treatment are performed in parallel in the aging step.

3. The method for producing a three-dimensional object according to claim 1, wherein the electron beam curable ink comprises at least one selected from the group consisting of a phosphine oxide-based photopolymerization initiator, an alkylphenone-based photopolymerization initiator, a thioxanthone-based photopolymerization initiator, an acyl phosphine oxide-based photopolymerization initiator, and a titanocene-based photopolymerization initiator as a photopolymerization initiator.

4. The method for producing a three-dimensional object according to claim 1, wherein the heat treatment applies a heat of 10° C. or more and 100° C. or less.
